(19) United States
(12) Patent Application Publication
(10) Pub. No.: US 2026/0112556 A1
(43) Pub. Date: Apr. 23, 2026

(54) DIMMING AND COLOR-ADJUSTING POWER SUPPLY STRUCTURE AND SWITCHING DEVICE

(71) Applicant: Zhuhai Shengchang Electronics Co., Ltd., Zhuhai City (CN)

(72) Inventors: Jialong HU, Zhuhai City (CN); Dehua ZHENG, Zhuhai City (CN)

(21) Appl. No.: 18/963,856

(22) Filed: Nov. 29, 2024

(30) Foreign Application Priority Data
Oct. 23, 2024 (CN) 2024225688857

(51) Int. Cl. H01H 23/14; H01H 15/10; H01H 23/08

(52) U.S. Cl. CPC H01H 23/148; H01H 15/10; H01H 23/08; H01H 2221/014; H01H 2221/016

(57) ABSTRACT

The present disclosure belongs to a dimming and color-adjusting power supply structure and a switching device. The dimming and color-adjusting power supply structure comprises a base and a fixed plate; the base is provided with a switch base, a circuit board, and a wiring terminal; the switch base is electrically connected to the circuit board; the wiring terminal is provided with a wire connected to the switch base; the fixed plate is arranged at an upper end of the base; the fixed plate is provided with a switch panel; the switch panel is provided with a button and a brightness and color temperature adjustment device; the button cooperates with the switch base; the brightness and color temperature adjustment device is electrically connected to the circuit board; and a bottom surface of the switch panel is connected to the fixed plate by a screw.

### TECHNICAL FIELD

The present disclosure relates to the technical field of switches, particularly to dimming and color-adjusting power supply structure and switching device.

### BACKGROUND

With the increasing improvement of people's living standards, their requirements for switching devices are also becoming higher, not only for functional requirements but also for safety. In terms of installation, the switch base of the prior art is arranged on a fixed plate, and the switch inside the switch base is electrically connected to the circuit board. The input wires of the switches are exposed outside after passing through the wire protection sleeve, and are connected to the plurality of components by wires that are interrelated. During the production process, installation needs to be carried out after gluing, and the fixing block needs to be placed next to the base during gluing. At this time, the input wire needs to be stretched out of the base, and after filling the adhesive, pull it back out of the base until the installation position is suitable. However, due to the wire being covered by adhesive, it is difficult to control the position of the output wire when pulled back. Moreover, during the pulling process, the colloid will flow out and cause contamination of the product's appearance. In addition, the switch panels of the prior art are detachable or have anti disassembly structures that are simple and easy to disassemble, which may pose certain safety hazards.

### SUMMARY

The technical problem to be solved by the present disclosure is to overcome the shortcomings of prior art, and the first objective is to provide a dimming and color-adjusting power supply structure that is easy to arrange and has high safety.

The present disclosure provides a switching device that is easy to arrange and has high safety.

The technical solution adopted by the present disclosure is: the dimming and color-adjusting power supply structure comprises a base and a fixed plate; the base is provided with a switch base, a circuit board, and a wiring terminal; the switch base is electrically connected to the circuit board; the wiring terminal is provided with a wire connected to the switch base; the fixed plate is arranged at an upper end of the base; the fixed plate is provided with a switch panel; the switch panel is provided with a button and a brightness and color temperature adjustment device; the button cooperates with the switch base; the brightness and color temperature adjustment device is electrically connected to the circuit board; and a bottom surface of the switch panel is connected to the fixed plate by a screw.

Furthermore, the dimming and color-adjusting power supply structure according to claim 1, further comprising: a junction box; the base is located in the junction box; a receiving cavity is separated by an isolation member inside the junction box; the isolation member is rotatably connected to a bottom portion of the base through a rotating shaft.

Furthermore, the junction box is provided with a knock off hole.

Furthermore, the isolation member is provided with a positioning portion and a limiting portion; the base is provided with a positioning hole that cooperates with the positioning portion; the limiting portion is correspondingly arranged with the rotating shaft.

Furthermore, the isolation member is provided with a plurality of cutting line.

Furthermore, the number of the wiring terminal is at least two; the wiring terminal is provided with a wire protection sleeve; the wire protection sleeve is opened with a threading hole; and the wire passes through the threading hole.

Furthermore, the brightness and color temperature adjustment device comprises an adjusting push rod and a potentiometer; the switch panel is provided with a limit hole; the adjusting push rod is arranged inside the limiting hole; and the potentiometer is connected to the adjusting push rod and electrically connected to the circuit board.

Furthermore, the base is also provided with an insulating member; and the insulating member is opened with a avoiding notch.

In addition, the present disclosure further provides a switching device, comprising the dimming and color-adjusting power supply structure.

The beneficial effects of the present disclosure are as follows.

Compared to the shortcomings of prior art, in the present disclosure, when the fixed plate is detached from the base during the glue filling process, the switch base is arranged on the base instead of the fixed plate, so that the fixed plate will not involve the wire connected to the switch base when opened. Therefore, after the glue filling is completed, there is no need to pull the wire back again to ensure the installation accuracy of the wire and avoid the situation where the glue flows out and pollutes the product, making the dimming and color-adjusting power supply structure easy to arrange. In addition, by connecting screws to the bottom surface of the switch panel, it is difficult for external tools to disassemble the switch panel, thereby avoiding safety hazards and improving safety, making the dimming and color-adjusting power supply structure highly secure.

### BRIEF DESCRIPTION OF THE DRAWINGS

In order to provide a clearer explanation of the embodiments of the present disclosure or the technical solutions in the prior art, the following will briefly introduce the drawings required for the description of the embodiments or the prior art. It is obvious that the drawings described below are only some embodiments of the present present disclosure. For those skilled in the art, other drawings can be obtained based on the structures shown in these drawings without creative labor.

FIG. 1 is a first schematic diagram of a three-dimensional structure of the present disclosure.

FIG. 2 is a second schematic diagram of a three-dimensional structure of the present disclosure.

FIG. 3 is a first exploded schematic diagram of the present disclosure.

FIG. 4 is a partially enlarged schematic diagram of part A of FIG. 3.

FIG. 5 is a second exploded schematic diagram of the present disclosure.

### DETAILED DESCRIPTION

The following will provide a clear and complete description of the technical solution in the embodiments of the present disclosure with reference to the drawings. Obviously, the described embodiments are only a part of the embodiments of the present disclosure, not all of them. Based on the embodiments in the present disclosure, all other embodiments obtained by ordinary skilled persons in the are without creative labor are within the scope of protection of the present disclosure.

It should be noted that all directional indications in this embodiment of the present disclosure, such as up, down, left, right, front, back, clockwise, counterclockwise, etc., are only used to explain the relative position relationship and motion of each component in a specific posture. If the specific posture changes, the directional indication will also change accordingly.

In addition, the descriptions of “first”, “second”, etc. in the present disclosure are only for descriptive purposes and cannot be understood as indicating or implying their relative importance or implying the number of technical features indicated. Therefore, the features that are limited to “first” and “second” can explicitly or implicitly comprise at least one of these features. In addition, the technical solutions between various embodiments can be combined with each other, but they must be based on the ability of ordinary technical personnel in the art to implement them. When the combination of technical solutions is contradictory or impossible to achieve, it should be considered that this combination of technical solutions does not exist and is not within the scope of protection required by the present disclosure.

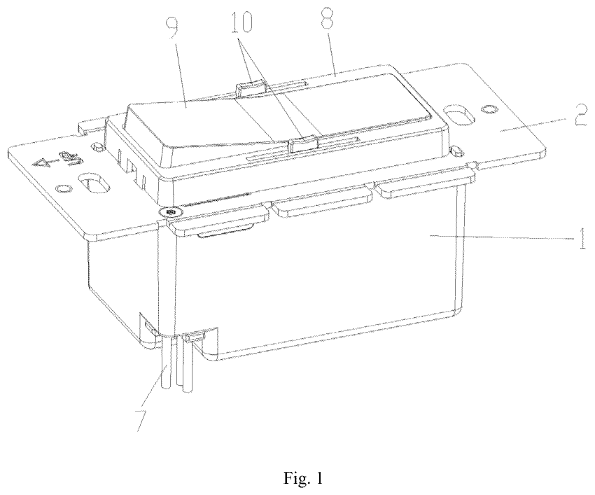

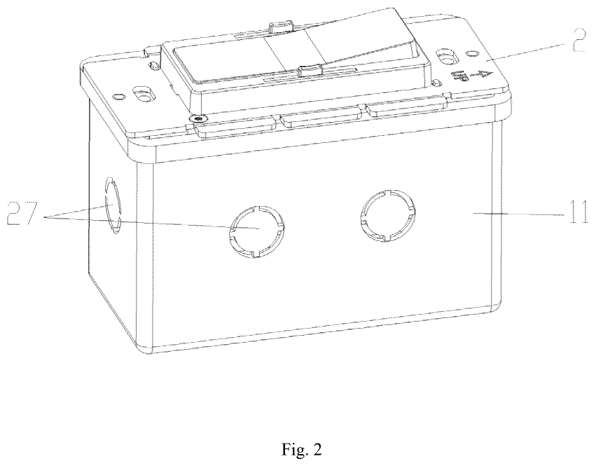

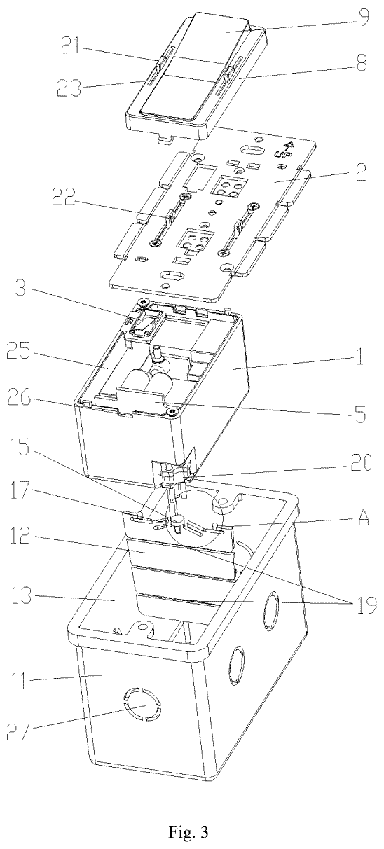

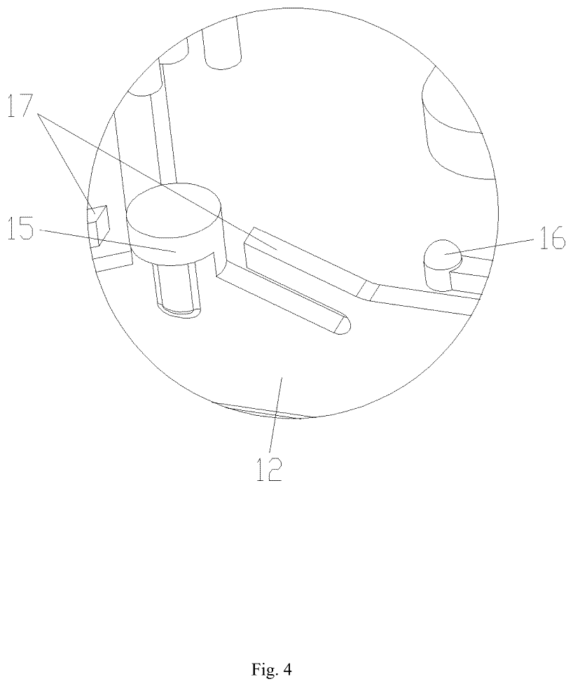

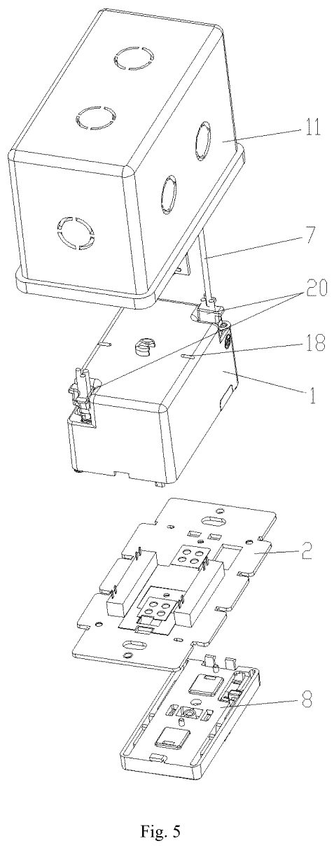

As shown in FIG. 1 to FIG. 5, in this embodiment, the dimming and color-adjusting power supply structure, comprises a base 1 and a fixed plate 2; the base 1 is provided with a switch base 3, a circuit board 5, and a wiring terminal; the switch base 3 is electrically connected to the circuit board 5; the wiring terminal is provided with a wire 7 connected to the switch base 3; the fixed plate 2 is arranged at an upper end of the base 1; the fixed plate 2 is provided with a switch panel 8; the switch panel 8 is provided with a button 9 and a brightness and color temperature adjustment device 10; the button 9 cooperates with the switch base 3; the brightness and color temperature adjustment device 10 is electrically connected to the circuit board 5; and a bottom surface of the switch panel 8 is connected to the fixed plate 2 by a screw. Wherein, the button 9 comprises a rocker plate, which is provided with two corresponding button portions and a pressure block. When the button portion is pressed, the pressure block located on the rocker plate will press down on the switch seat 3, thereby achieving the power on or off of the switch.

Compared to the shortcomings of prior art, in the present disclosure, when the fixed plate 2 is detached from the base 1 during the glue filling process, the switch base 3 is arranged on the base 1 instead of the fixed plate 2, so that the fixed plate 2 will not involve the wire 7 connected to the switch base 3 when opened. Therefore, after the glue filling is completed, there is no need to pull the wire 7 back again to ensure the installation accuracy of the wire 7 and avoid the situation where the glue flows out and pollutes the product, making the dimming and color-adjusting power supply structure easy to arrange. In addition, by connecting screws to the bottom surface of the switch panel 8, it is difficult for external tools to disassemble the switch panel 8, thereby avoiding safety hazards and improving safety, making the dimming and color-adjusting power supply structure highly secure.

In some embodiments, the dimming and color-adjusting power supply structure further comprising: a junction box 11; the base 1 is located in the junction box 11; a receiving cavity 13 is separated by an isolation member 12 inside the junction box 11; the isolation member 12 is rotatably connected to a bottom portion of the base 1 through a rotating shaft 15. the junction box 11 is provided with a knock off hole 27. the isolation member 12 is provided with a positioning portion 16 and a limiting portion 17; the base 1 is provided with a positioning hole 18 that cooperates with the positioning portion 16; the limiting portion 17 is correspondingly arranged with the rotating shaft 15. the isolation member 12 is provided with a plurality of cutting line 19. Specifically, there are two receiving cavities 13 separated by the isolation members 12 for accommodating cables. When installing, install the rotating shaft 15 on the rotating seat of the base 1 and rotate the rotating shaft 15 to the limiting portion 17 to achieve installation. In addition, the isolation member 12 can rotate back and forth to adjust the relative size of the two receiving cavities 13. In addition, the plurality of cutting lines 19 are arranged on the isolation member 12 to meet different depth dimensions required, thus better compatible with the junction box 11.

In some embodiments, the number of the wiring terminal is at least two; the wiring terminal is provided with a wire protection sleeve 20; the wire protection sleeve 20 is opened with a threading hole; and the wire 7 passes through the threading hole. Wherein, at least one wiring terminal is an input wiring terminal, and at least one wiring terminal is an output wiring terminal.

In some embodiments, the brightness and color temperature adjustment device 10 comprises an adjusting push rod 21 and a potentiometer 22; the switch panel 8 is provided with a limit hole 23; the adjusting push rod 21 is arranged inside the limiting hole 23; and the potentiometer 22 is connected to the adjusting push rod 21 and electrically connected to the circuit board 5. Wherein, there are two adjusting push rods 21 and potentiometers 22, which are respectively arranged on both sides of button 9. Specifically, during adjustment, the position of the adjustment push rod 21 in the limiting hole 23 is pushed to adjust the potentiometer 22, thereby achieving adjustment of brightness or color temperature.

In some embodiments, the base 1 is also provided with an insulating member 25; and the insulating member 25 is opened with a avoiding notch 26.

In addition, the present disclosure also provides a switching device comprising the dimming and color-adjusting power supply structure. The specific structure of the dimming and color-adjusting power supply structure is referred to in the above-mentioned embodiments, as the dimming and color-adjusting power supply structure adopts all the technical solutions of the above-mentioned embodiments, at least all the beneficial effects brought by the technical solutions of the above-mentioned embodiments will not be elaborated here.

The above description is only a preferred embodiments of the present disclosure and does not limit the scope of the patent of the present disclosure. Any equivalent structural transformation made under the inventive concept of the present disclosure using the content of the specification and drawings of the present disclosure, or directly/indirectly applied in other related technical fields, is included in the scope of patent protection of the present disclosure.

What is claimed is:

1. A dimming and color-adjusting power supply structure, comprising: a base and a fixed plate;
the base is provided with a switch base, a circuit board, and a wiring terminal;
the switch base is electrically connected to the circuit board;
the wiring terminal is provided with a wire connected to the switch base;
the fixed plate is arranged at an upper end of the base;
the fixed plate is provided with a switch panel;
the switch panel is provided with a button and a brightness and color temperature adjustment device;
the button cooperates with the switch base;
the brightness and color temperature adjustment device is electrically connected to the circuit board; and
a bottom surface of the switch panel is connected to the fixed plate by a screw.

2. The dimming and color-adjusting power supply structure according to claim 1, further comprising: a junction box;
the base is located in the junction box;
a receiving cavity is separated by an isolation member inside the junction box;
the isolation member is rotatably connected to a bottom portion of the base through a rotating shaft.

3. The dimming and color-adjusting power supply structure according to claim 2, wherein
the junction box is provided with a knock off hole.

4. The dimming and color-adjusting power supply structure according to claim 2, wherein
the isolation member is provided with a positioning portion and a limiting portion;
the base is provided with a positioning hole that cooperates with the positioning portion;
the limiting portion is correspondingly arranged with the rotating shaft.

5. The dimming and color-adjusting power supply structure according to claim 4, wherein
the isolation member is provided with a plurality of cutting line.

6. The dimming and color-adjusting power supply structure according to claim 1, wherein
the number of the wiring terminal is at least two;
the wiring terminal is provided with a wire protection sleeve;
the wire protection sleeve is opened with a threading hole; and
the wire passes through the threading hole.

7. The dimming and color-adjusting power supply structure according to claim 1, wherein
the brightness and color temperature adjustment device comprises an adjusting push rod and a potentiometer;
the switch panel is provided with a limit hole;
the adjusting push rod is arranged inside the limiting hole; and
the potentiometer is connected to the adjusting push rod and electrically connected to the circuit board.

8. The dimming and color-adjusting power supply structure according to claim 1, wherein
the base is also provided with an insulating member; and
the insulating member is opened with an avoiding notch.
